(19) United States
(12) Patent Application Publication
(10) Pub. No.: US 2007/0143120 A1
(43) Pub. Date: Jun. 21, 2007

(54) System and method for configuring an input arrangement for a computing device

(76) Inventors: Amit Phadnis, Bangalore (IN); Mohan Dasarathan, Tamil Nadu (IN); Sumita Malik, Delhi (IN)

Correspondence Address: FAY KAPLUN & MARCIN, LLP, 15O BROADWAY, SUITE 702, NEW YORK, NY, 10038, US

(21) Appl. No.: 11/287,863

(22) Filed: Nov. 28, 2005

(51) Int. Cl. G06Q 99/00

(52) U.S. Cl. 705/1

(57) ABSTRACT

Described is a system comprising a computing device detachably coupled to an input arrangement. Upon authenticating a user, a corresponding user profile is retrieved from a memory module and uploaded into at least one of the device and the arrangement. The profile stores user's preferences for inputting data via the input arrangement. The memory module is situated in at least one of the device and the arrangement.

### BACKGROUND

Users of computing systems (e.g., desktops, laptops, personal digital assistants (“PDAs”), handheld computers, network interface devices, etc.) often desire to customize their keyboards. For instance, a user may prefer each key on the keyboard to represent something other than a standard character. For example, the user may desire to enter text in Chinese, and thus may require that each key and/or combination of keys represents a different Chinese character. Presently, however, the user must first reconfigure the keyboard from a current setting (e.g., in English) to a customized setting (e.g., Chinese). Because the current setting remains the same for all users, each user must reconfigure the keyboard to the customized setting prior to using the computing system. Accordingly, excessive time and energy are expended in altering the keyboard settings.

### SUMMARY OF THE INVENTION

The present invention relates to a system comprising a computing device detachably coupled to an input arrangement. Upon authenticating a user, a corresponding user profile is retrieved from a memory module and uploaded into at least one of the device and the arrangement. The profile stores user's preferences for inputting data via the input arrangement. The memory module is situated in at least one of the device and the arrangement.

### BRIEF DESCRIPTION OF THE DRAWINGS

FIG. 1 shows an exemplary embodiment of a system according to the present invention;

FIG. 2 shows another exemplary embodiment of an input arrangement according to the present invention; and

FIG. 3 shows an exemplary embodiment of a method according to the present invention.

### DETAILED DESCRIPTION

The present invention may be further understood with reference to the following description and the appended drawings, wherein like elements are referred to with the same reference numerals. The present invention describes a system and a method for configuring an input arrangement. Although the present invention will be described with respect to a keyboard which may be compatible with stationary and/or mobile computing devices, those of skill in the art will understand that the present invention may be applied to any system utilizing a keyboard/keypad as an input device (e.g., a desktop computer). Further, the present invention may be applied to any peripheral coupled to the terminal, such as a mouse, a webcam, speakers, etc.

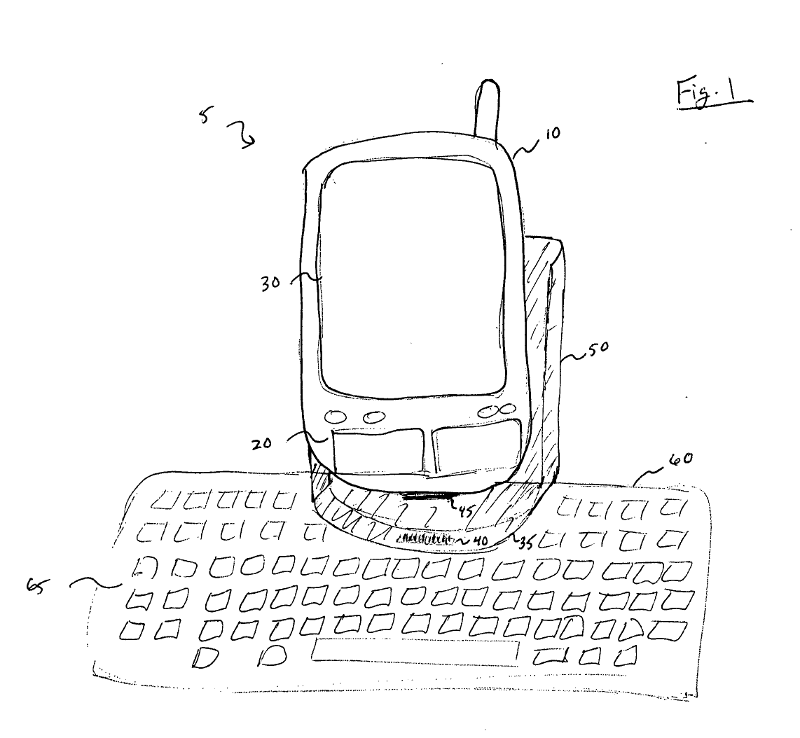

FIG. 1 shows an exemplary embodiment of a system 5 according to the present invention. The system 5 may include a terminal (e.g., a mobile terminal 10, a stationary terminal) including input keys 20 and a display 30. It will be understood by those of skill in the art that the mobile terminal 10 may be any wireless device including, but not limited to, a cell phone, a laptop, a network interface card, a handheld computer, a PDA, a personal computer, an image- or laser-based scanner, an RFID reader, etc. A user of the mobile terminal 10 may enter information via the input keys 20 and/or a touch panel which may be integral with the display 30. However, the user may deem these methods of entering information inadequate, because perhaps they may not be performed with enough expediency. The user may desire to enter information with the same quickness and ease as entering information via a keyboard. Thus, the mobile device 10 may be detachably coupled to a keyboard 60. The keyboard 60 may be a full/standard sized keyboard with a standard key arrangement 65, or it may be modified (e.g., smaller, fewer keys, different key arrangement, etc.).

In the exemplary embodiment of FIG. 1, the mobile terminal 10 may be mounted in a receptacle 35 of the keyboard 60. A support 50 may extend from the receptacle 35 in order to stabilize the mobile terminal 10. As shown, a communications link may be established by connecting a female part 40 to a male part 45 which are located on the keyboard 60 and the mobile terminal 10 respectively. However, it will be understood by those of skill in the art that the communications link may be provided by a variety of other devices (e.g., infrared links, USB, etc.). For example, the communications link may be a wireless connection in which case the mobile terminal 10 and the keyboard 60 may not be physically coupled together.

When using the system 5, the user may desire to enter specialized information. For example, the user may wish to type information in a foreign language which utilizes a different alphabet. Accordingly, the user may execute an application or alter a setting on the mobile terminal 10 and/or the keyboard 60 to enter the specialized information. In a conventional system, the user may be required to set his keyboard preferences each time he desires to enter the specialized information. Further, other users may similarly wish to use their custom keyboard preferences. In such a case, the conventional system may retain only the preferences of a most recent user requiring each subsequent user to manually reconfigure the keyboard. However, according to the present invention, a profile may be created for each user, which would enable the user's keyboard preferences to automatically load.

The profile may include information and settings specific to the user, such as the keyboard preferences. The keyboard preferences may be those settings which enable the user to input the specialized information, such as foreign text. Further, the keyboard preferences may include one or more keystrokes which trigger a particular function (e.g., macros, shortcut keys, hotkeys, etc.). For example, the user may configure the keyboard preferences such that an application is executed if the <Alt>, <Shift>, and <F9> keys are simultaneously depressed.

In one exemplary embodiment of the present invention, the profile may be stored on the keyboard 60. This embodiment may be preferable for a user that desires to use the keyboard 60 to input information into multiple mobile terminals.

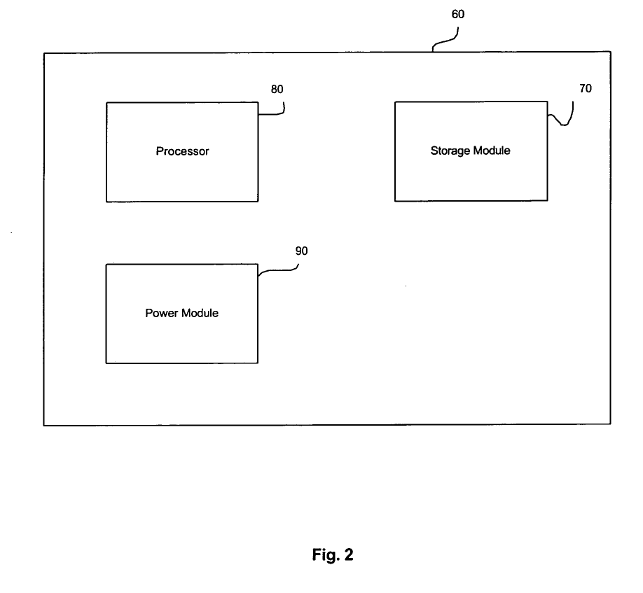

FIG. 2 shows an exemplary embodiment of input arrangement (e.g., a keyboard 60) on which one or more profiles may be stored. As shown, the keyboard 60 may include a storage module 70, a processor 80, and a power module 90.

The storage module 70 may include a removable memory and/or a non-removable memory. The removable memory may be any type of detachable memory component that may connect to the keyboard 60 through an expansion interface (e.g., a FLASH interface, a USB interface, a firewire interface, etc.). The non-removable memory is any type of memory component integrated into the electronic architecture of the keyboard 60 and may be temporary (e.g., random access memory, or RAM) or permanent (e.g., a hard-disk drive). The storage module 70 may store one or more of the profiles.

The processor 80 may facilitate communication between the keyboard 60 and the mobile terminal 10. For example, the processor 80 may load the profile and communicate to the terminal 10 the profile which may be shown on the display 30. Further the processor 80 may facilitate a process of authenticating a user. In one embodiment of the present invention, the keyboard 60 may also include a display (not shown) which shows information that allows the user to select a particular profile from the one or more profiles stored in the storage module 70. For example, the display may prompt the user for authentication data (e.g., a login) and/or it may list one or more profiles that may be selected by the user.

The power module 90 may supply the keyboard 60 with a requisite energy supply to store and load the profile(s). A type of power module 90 may vary depending on a type of terminal with which the keyboard 60 is to be used. For example, a keyboard used in conjunction with the mobile terminal 10 may preferably be powered by a battery. Additionally or alternatively, however, the keyboard 60 may include a plug for coupling to an electrical outlet. In a further example, the keyboard 60 may derive its power through the mobile terminal 10 to which it is connected (e.g., USB connection).

In another exemplary embodiment, the keyboard 60 may not contain a separate processor 80. Rather, the keyboard 60 may include circuitry, which may be used in conjunction with a central processing unit of the mobile terminal 10 to which it is coupled. For example, the circuitry may map a user's keyboard preferences and pass the preferences to a driver (e.g., a keyboard driver) on the mobile terminal 10 and/or the keyboard 60.

In another exemplary embodiment of the present invention, the profile(s) may be stored on the mobile terminal 10. This embodiment may be preferable if a user desires to use the mobile terminal 10 in conjunction with multiple detachable keyboards and/or when multiple users utilize a single terminal. For example, a user may own several keyboards so that he may keep one at home, one at work, and one at a weekend home. However, the user may use each of these keyboards to enter information into the same mobile terminal 10. Storing user preferences on each individual keyboard may be excessively troublesome. Accordingly, the user may desire to store the profile on the mobile terminal 10.

In yet another exemplary embodiment of the present invention, the profile may be stored on both the keyboard 60 and the mobile terminal 10. In this embodiment, a processor on the mobile terminal 10 may look in both locations to retrieve the profile. The profile may then be loaded from the location in which it was found. If the profile is located in both locations, the processor may use a default setting where, for example, it automatically loads the profile stored on the mobile terminal 10.

According to the present invention, the profile including the keyboard preferences may be loaded automatically. In one embodiment, the profile may be uploaded when the user enters a login name and/or password. In another embodiment, the profile may be selected by the user and accordingly loaded. For example, icons representing several profiles may be disposed on the display 30. The user may select one the icons (i.e., the icon representing his profile) in order to load his keyboard preferences. In yet another embodiment, the profile may be automatically loaded when a particular mobile terminal communicates with a particular keyboard.

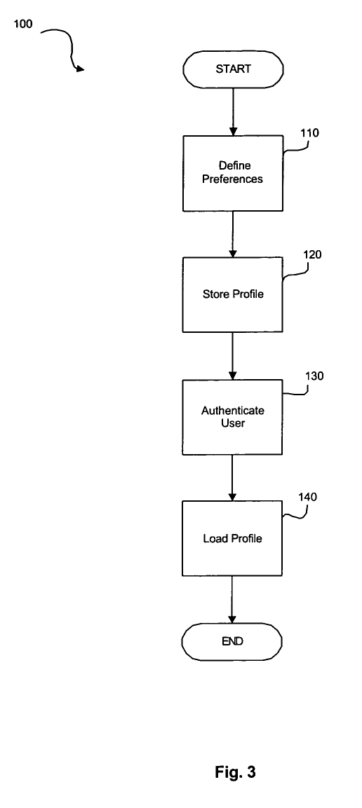

FIG. 3 shows an exemplary method 100 of the present invention. In step 110, the user defines one or more keyboard preferences including settings which enable the user to input specialized information. For example, the user may configure the key arrangement 65 of the keyboard 60 to correspond to Greek letters, thereby enabling the user to input Greek text. Further, the keyboard preferences may include one or more keystrokes which trigger a particular function (e.g., a macro). The profile may also include a variety of other information. For example, other types of preferences such as background settings for a display, applications available, passwords, etc. may be included in the profile. Each profile may be labeled to indicate its contents to the user. For example, the profile may be labeled according to the user (e.g., “Mary”) who defined the keyboard settings, the profile may be labeled according to a type of the specialized information (e.g., “Chinese”), etc.

In step 120, the profile may be stored on the mobile terminal 10 and/or the keyboard 60. Profiles of further users may similarly be stored along with the profile. However, the profiles may be specific to each user. That is, two profiles may include the same keyboard preferences, but the two profiles are stored separately and are only accessible by the respective users. Accordingly, the profiles will not interfere with one another. For example, a user profile may be closed when the user is no longer using the terminal, and thus the user's keyboard preferences will not be in effect when a new user enters information on the terminal.

After the profile has been created and stored, it may be utilized by the user(s). In step 130, the user is authenticated. That is, the user may attempt to log in to a system (e.g., a network, a PC, etc.). A login, for example, may require the user to enter user-specific data such as a username and/or a password. After the user enters the login, the user may be recognized by the system and thus authenticated. In this case, authentication may denote authorization to use one of the profiles.

In another embodiment of the present invention, authentication may be built into the keyboard 60. Thus, a user that is unfamiliar to the computing device may nonetheless be recognized by the keyboard, where the user's keyboard preferences may also be saved.

In step 140, the user has been authenticated, and the profile is automatically loaded. Accordingly, the user may immediately begin entering input via the keyboard 60 with the keyboard preferences. In one embodiment of the present invention, the user may also update his keyboard preferences, and periodically reconfigure the profile or store separate profiles. The user may be prompted to update the profile at predetermined times or the user may do so on his own accord. In one embodiment, the profile may be updated automatically each time it is loaded by the user.

In one embodiment of the present invention, users may generally only load their own user profiles (i.e., the user profiles which they defined and stored). However, it may be desirable for a particular user to have access to multiple user profiles. For example, an administrator may wish to load other user profiles in order to verify an appropriate content thereof. Accordingly, the administrator may be authorized to load and modify profiles of one or more users.

The present invention may be effective in saving time and effort of the user, particularly when entering specialized information. Additionally, the present invention may be helpful to a user who desires to store several user profiles. For example, the user may perform a series of tasks on one system 5, wherein each task requires a different set of preferences (e.g., a first task includes entering Russian text, a second task includes entering Chinese text, etc.). Accordingly, the user may load and exit each profile with relative ease in order to end and begin separate tasks.

The present invention may also prove beneficial in certain environments where one keyboard and/or terminal is shared by a plurality of users. For example, systems located in an office, a public library, an internet cafe, etc. may be accessed by multiple users. According to the present invention, each user may store his/her individual preferences in a corresponding profile, and load the preferences at each time of access.

Although the present invention has been described with respect to a mobile terminal used in conjunction with a detachable keyboard, it will be understood by those of skill in the art that the present invention may be used with any computing system which utilizes a keyboard to input information. Further, it is not necessary that a standard keyboard be used. For example, the present invention may also be applicable to keypads, number pads, and the like.

It will also be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a computing device; and
an input arrangement detachably coupled to the device,
wherein, upon authenticating a user, a corresponding user profile is retrieved from a memory module and uploaded into at least one of the device and the arrangement, the profile storing user's preferences for inputting data via the input arrangement, the memory module being situated in at least one of the device and the arrangement.

2. The system according to claim 1, wherein at least one of the device and the arrangement is configured as a function of the profile.

3. The system according to claim 1, wherein the device includes one of a cell phone, a laptop, a network interface card, a handheld computer, a PDA, a personal computer, an image-based scanner, a laser-based scanner and an RFID reader.

4. The system according to claim 1, wherein the arrangement is a keyboard.

5. The system according to claim 1, wherein the arrangement is coupled to the device via a communications link.

6. The system according to claim 5, wherein the communications link is one of an infrared link, a radio frequency link, a serial link and a USB link.

7. The system according to claim 1, wherein the user's preferences include at least one of a language, a shortcut key, a macro, a hotkey and a display setting.

8. The system according to claim 1, wherein the memory module is a memory card coupleable to the at least one of the device and the arrangement.

9. The system according to claim 1, wherein the user is authenticated when authentication data is received by at least one of the device and the arrangement.

10. The system according to claim 1, wherein the authentication data includes at least one of a user ID, a user password and an arrangement ID.

11. The system according to claim 1, wherein the corresponding user profile includes a plurality of subprofiles.

12. A method, comprising:
coupling an input arrangement to a computing device;
authenticating a user of the input arrangement;
retrieving a corresponding user profile from a memory module, the profile storing user's preferences for inputting data via the input arrangement, the memory module being situated in at least one of the device and the arrangement; and
uploading the profile into at least one of the device and the arrangement.

13. The method according to claim 12, further comprising:
configuring the device and the arrangement as a function of the profile.

14. The method according to claim 12, wherein the device is one of a cell phone, a laptop, a network interface card, a handheld computer, a PDA, a personal computer, an image-based scanner, a laser-based scanner and an RFID reader.

15. The method according to claim 12, wherein the arrangement is a keyboard.

16. The method according to claim 12, wherein the arrangement is coupled to the device via a communications link.

17. The method according to claim 16, wherein the communications link is one of an infrared link, a radio frequency link, a serial link and a USB link.

18. The method according to claim 12, wherein the user's preferences include at least one of a language, a shortcut key, a macro, a hotkey and a display setting.

19. The method according to claim 12, wherein the memory module is a memory card coupleable to at least one of the device and the arrangement.

20. The method according to claim 12, wherein after the authenticating step, the method further comprising:
displaying a profile menu including at least one further profile selectable by the user.

21. An input arrangement, comprising:
a processor;
a communications arrangement establishing a communication link with a computing device; and
a memory module,
wherein, upon authenticating a user, a corresponding user profile is retrieved from the memory module and uploaded into at least one of the device and the arrangement, the profile storing user's preferences for inputting data via the input arrangement.

22. The arrangement according to claim 21, wherein the communications arrangement is one of a USB port, an infrared port and a serial port.

23. The arrangement according to claim 21, wherein the arrangement is a keyboard.
